(19) United States
(12) Patent Application Publication
(10) Pub. No.: US 2019/0049215 A1
(43) Pub. Date: Feb. 14, 2019

(54) SEAT BELT FIREARM HOLSTER

(71) Applicant: Mark TALBOT, Queen Creek, AZ (US)

(72) Inventor: Mark TALBOT, Queen Creek, AZ (US)

(21) Appl. No.: 15/671,378

(22) Filed: Aug. 8, 2017

(51) Int. Cl. F41C 33/04; B60R 7/14

(52) U.S. Cl. CPC F41C 33/041; F41C 33/06; F41C 33/046; B60R 7/14

(57) ABSTRACT

A seat belt holster may include a holster body defining a handgun receiving pocket for receiving a firearm. A seat belt holster may include a seat belt buckle attachment coupled to the holster body and a seat belt anchor receptacle coupled the holster body. Some seat belt holsters may include a seat belt buckle attachment coupled to a first side of the seat belt holster body to secure the seat belt holster body to a vehicle seat belt component, and include a seat belt anchor receptacle, coupled to a second side of the seat belt holster body, enabling the seat belt anchor receptacle to selectively receive and actuate attachment to a vehicle seat belt connector. Some seat belt holsters may include a belt coupled to the holster and connected to the seat belt anchor receptacle and the seat belt buckle attachment. Some seat belt holsters may include an IoT device.

### BACKGROUND OF THE INVENTION

### Field of the Invention

The present invention relates generally to shooting sports, and more particularly to, a seat belt firearm holster for use with vehicular safety belts.

### Description of the Related Art

Law enforcement officers, and particularly shooters who have a need or interest to carry a handgun normally do so in a holster, and it is important that the handgun be secure in the holster against falling out when the wearer is running or otherwise involved in activity, and against the possibility of withdrawal by someone other than the wearer. However, storage and transportation of firearms is a problem for anyone that must do it on a regular basis. Many individuals find that they would like to have access to their firearm, particularly when in a vehicle, but typically require the holster to be removed from being attached to the wearer.

### SUMMARY OF THE INVENTION

Various embodiments provide a seat belt firearm holster for use with vehicular safety belts. A seat belt holster may include a holster body defining a handgun receiving pocket for receiving a firearm. A seat belt holster may include a male seat belt buckle attachment coupled to a first side of the holster body. A seat belt holster may include a seat belt anchor receptacle coupled to a second side of the holster body.

### BRIEF DESCRIPTION OF THE DRAWINGS

So that the advantages of the invention are readily understandable, a more particular description of the invention briefly described above is rendered by reference to specific embodiments that are illustrated in the appended drawings. Understanding that these drawings depict only typical embodiments of the invention and are not therefore to be considered to be limiting of its scope, the invention is described and explained with additional specificity and detail through the use of the accompanying drawings, in which:

FIG. 1 is a side view of one embodiment of a seat belt firearm holster for use with vehicular safety belts;

FIG. 2 is a rear view of the seat belt firearm holster of FIG. 1;

FIG. 3 are diagrams of one embodiment of an adjustable seat belt firearm holster of FIG. 1, having a rotating clip, allowing for the adjustable seat belt holster to be in multiple positions;

FIG. 4 is a diagram of one embodiment of an adjustable seat belt firearm holster of FIG. 1 having seat belt buckle attachments secured therein;

FIG. 5A-5B are additional diagrams of an adjustable seat belt firearm holster of FIG. 1, having a rotating clip, allowing for the adjustable seat belt holster to be in multiple positions;

FIG. 6 is a block diagram depicting an exemplary computing node according to an embodiment of the present invention;

FIG. 7 is an additional block diagram depicting an exemplary cloud computing environment according to an embodiment of the present invention; and

FIG. 8 is an additional block diagram depicting abstraction model layers according to an embodiment of the present invention.

### DETAILED DESCRIPTION

The various embodiments illustrated below provide an adjustable seat belt holster enabled to attach and detach from a seat belt system of a vehicle. The various embodiments include features that enable a user to comfortably secure a seat belt holster for a firearm (e.g., a handgun) to a seat belt system of a vehicle while adjusting the seat belt holster to one or more positions while the user is secured to the seat belt of the vehicle.

Also, as used herein, a vehicle may be an automobile, bicycle, hovercraft, scooter, bus, motorcycle, boat, ship, aircraft, plane, helicopter, drone, off road vehicle, truck, tractor, and/or other device used for movement or transportation.

In one aspect, a seat belt holster is provided for use with vehicular safety belts. A seat belt holster may include a holster body defining a handgun receiving pocket for receiving a firearm. A seat belt holster may include a male seat belt buckle attachment coupled to a first side of the holster body enabling the male seat belt buckle attachment to secure the seat belt holster body to a vehicle seat belt component. The seat belt holster may include a seat belt anchor receptacle, coupled to a second side of the seat belt holster body, having a seat belt securing mechanism contained therein enabling the seat belt anchor receptacle to selectively receive and actuate attachment to a vehicle male seat belt connector. The seat belt holster may include an extension belt attached to an outer portion of the seat belt holster body and connected to the seat belt anchor receptacle and the male seat belt buckle attachment.

In one aspect, the seat belt holster may include a rotating button attached to an outer surface of the holster body enabling the holster body to rotate to one of a plurality of temporary fixed positions. The seat belt holster may include a holding plate attached to the rotating button, the rotating button including a quick release clip enabling the holster body to be released from the holding plate. In an additional aspect, the seat belt holster may include the extension belt traversing through the holding plate and connected to the seat belt anchor receptacle and the male seat belt buckle attachment. Thus, the seat belt holster provides a wearer of the seat belt holster access to their firearm, particularly when in a vehicle, without requiring the seat belt holster be removed from being attached to the wearer.

In an additional aspect, the present invention provides for a seat belt holster apparatus, comprising: a seat belt holster body defining a handgun receiving pocket for receiving a firearm; a male seat belt buckle attachment coupled to a first side of the seat belt holster body, the male seat belt buckle attachment having a retention means enabling the male seat belt buckle attachment to secure the seat belt holster body to a vehicle seat belt component; a seat belt anchor receptacle, coupled to a second side of the seat belt holster body, having a seat belt securing mechanism contained therein enabling the seat belt anchor receptacle to selectively receive and actuate attachment to a vehicle male seat belt connector; and an extension belt traversing through the holding plate and connected to the seat belt anchor receptacle and the male seat belt buckle attachment.

The seat belt holster may have a securing channel traversing along at least a portion of the outer edges of the seat belt holster, wherein the securing channel enables the male seat belt buckle attachment and the seat belt anchor receptacle to slidably adjust to one or more locking positions. The retention means may be a plate having a first portion and a second portion forming a non-planer, s-shaped plate, the first portion at least partially housed within the seat belt holster and the second portion having an aperture to adaptively install within a vehicle seat belt component. The first portion of the plate may be at least one inch in length and the second portion is at least 2 inches in length. A rotating locking clip may be attached to an outer surface of the seat belt holster body enabling the seat belt holster body to rotate to one of a plurality of temporary locking positions. A pad may be coupled to at least a portion of the holster body.

As an additional embodiment, the present invention provides for a seat belt holster that may include a holster body defining a handgun receiving pocket for receiving a firearm. The seat belt holster may include a male seat belt buckle attachment coupled to the holster body and a seat belt anchor receptacle coupled the holster body. The seat belt holster may include a male seat belt buckle attachment coupled to a first side of the seat belt holster body to secure the seat belt holster body to a vehicle seat belt component, and include a seat belt anchor receptacle, coupled to a second side of the seat belt holster body, enabling the seat belt anchor receptacle to selectively receive and actuate attachment to a vehicle male seat belt connector. The seat belt holster may include an extension belt coupled to a holster and connected to the seat belt anchor receptacle and the male seat belt buckle attachment. The seat belt holster may include one or more Internet of Things (IoT) devices.

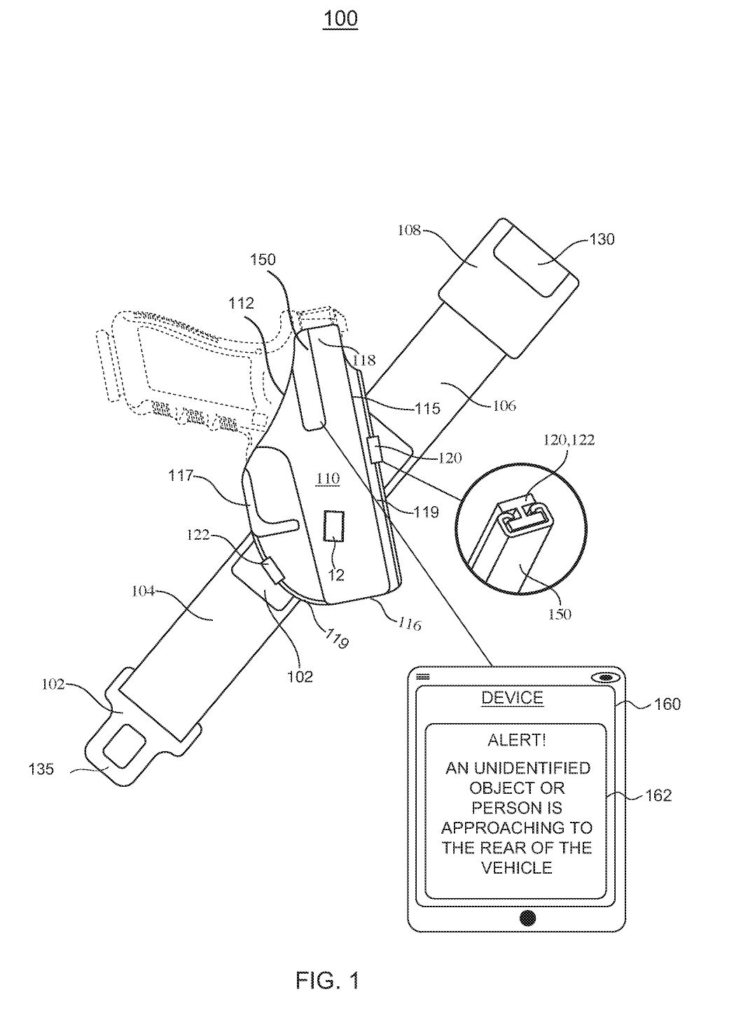

Turning now to the figures, FIG. 1 is a view of one embodiment of seat belt firearm holster 100 for use with vehicular safety belts. The seat belt firearm holster 100 may be made out of any material known in the art or developed in the future. Examples of suitable materials include, but are not limited to, plastic, metal, a composite material, cloth, leather, a carbon fiber material, or combinations thereof.

As illustrated in FIG. 1, seat belt firearm holster 100 comprises a seat belt holster body 110 defining a handgun receiving pocket 112 for receiving a firearm such as, for example, a pistol. The seat belt firearm holster 100 may include a male seat belt buckle attachment 102 and a female seat belt buckle attachment 108 (e.g., a seat belt anchor receptacle). The seat belt firearm holster 100 may also include one or more Internet of Things (IoT) sensor-based devices, such as IoT sensor-based device 150.

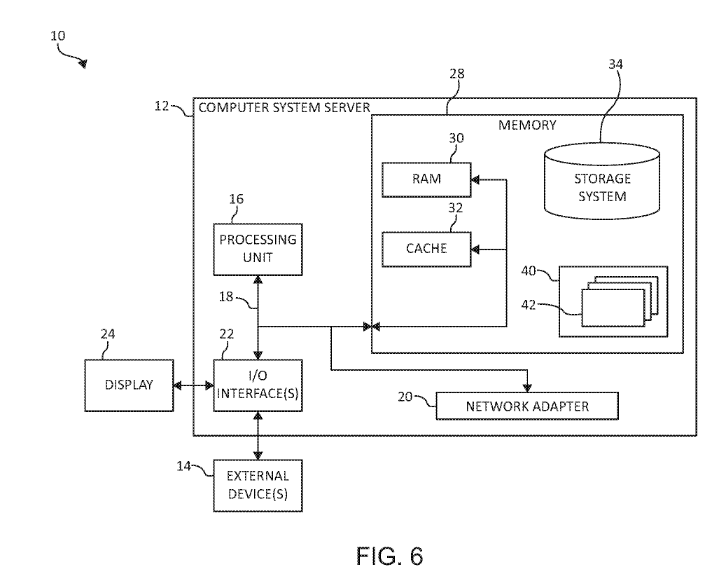

The seat belt firearm holster 100 may include the computing environment 12 (see FIG. 6 for further details) that may have one or more processors and memory and be in communication with one or more Internet of Things (IoT) sensor-based devices, such as IoT sensor-based device 150. The computing environment 12 may be located within the seat belt firearm holster 100 and associated with and/or in communication with IoT sensor-based device 150, by one or more communication methods, such as a computing network. In one example, the computing environment 12 may be controlled by a wearer or person associated with the computing environment 12. In another example, the computing environment 12 may be completely independent from the wearer of the seat belt firearm holster 100.

In one aspect, the computing environment 12 may provide virtualized computing services (i.e., virtualized computing, virtualized storage, virtualized networking, etc.) to device(s) 120. More specifically, the computing environment 12 may provide virtualized computing, virtualized storage, virtualized networking and other virtualized services that are executing on a hardware substrate.

The IoT sensor based devices may be in communication with an IoT communication network. In one aspect, the one or more Internet of Things (IoT) sensor-based devices, such as IoT sensor-based device 150, may be proximity sensors, cameras, radio frequency identification “RFID” readers, biometric sensors, wearable sensors, computers, interactive-voice detection system, wireless communication equipment, handheld devices (e.g., Global Positioning System “GPS” device or step counters), and/or other audible, camera, or sensor based devices. The one or more Internet of Things (IoT) camera or sensor-based devices, such as IoT camera or sensor-based device 150, may receive and/or detect various types of data such as, for example, data relating to attachment/detachment of the seat belt firearm holster 100 from either the male seat belt buckle attachment 102 or a female seat belt buckle attachment 108 (e.g., a seat belt anchor receptacle). The IoT sensor-based device 150 may also be used for determining biometric data associated with the wearer. For example, a locking means associated with the IoT sensor-based device 150 may prevent attachment/detachment of the seat belt firearm holster 100 to/from either the male seat belt buckle attachment 102 or female seat belt buckle attachment 108 (e.g., a seat belt anchor receptacle). The IoT sensor-based device 150 may communicate the detected data to a computing device 160 (having an interactive graphical user interface “GUI” 162) associated with the wearer.

In one aspect, one or more Internet of Things (IoT) sensor-based devices, such as IoT camera or sensor-based device 150, may be in communication with a vehicle or vehicular collaboration system so as to include using images, video, sounds, or other sensor-based device data via a social “car-net” through sharing of information. The collaborative data may be combined to form a 360-degree view of the vehicle capable of being displayed such as, for example, in a display system of the vehicle and providing an alert notification to the IoT camera or sensor-based device 150. For example, in operation the vehicle communication system (which may include one or more cameras) may detect an unidentified object or person approaching the vehicle. The vehicle communication system of the vehicle may relay and communicate this information to the IoT camera or sensor-based device 150. Using this information, the IoT camera or sensor-based device 150 may then execute an alert to the wearer (e.g., such as a vibration, audible, and/or visual notification). Also, the IoT camera or sensor-based device 150 may send a command to seat belt firearm holster 100 to automatically attach or detach the seat belt firearm holster 100 to/from either the male seat belt buckle attachment 102 or female seat belt buckle attachment 108 (e.g., a seat belt anchor receptacle).

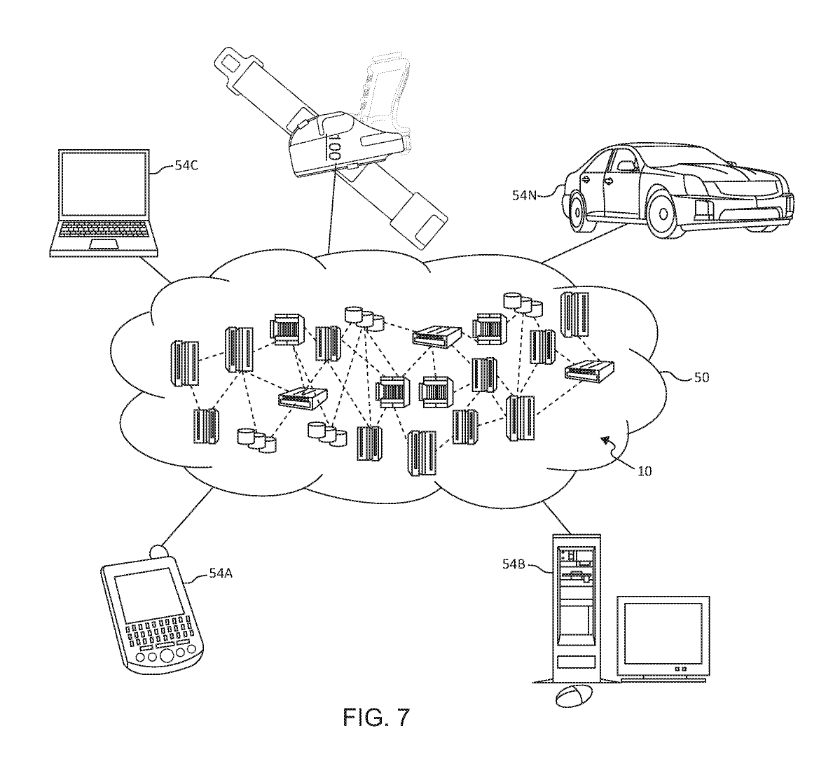

As an additional example, the IoT camera or sensor-based device 150 may detect that the seat belt firearm holster 100 is approaching or leaving a vehicle associated with a list of known vehicles associated with the wearer. One or more communication signals may be communicated via the seat belt firearm holster 100 using the IoT camera or sensor-based device 150 and/or processor (see FIG. 7) to provide instructions to the vehicle to execute one or more commands. For example, the commands may include, but are not limited to, unlocking/locking a vehicle, starting an engine of the vehicle, executing a communication message (e.g., text, email, telephone call) to a known associate or vehicle, sending an emergency command to a local emergency service provider (e.g., law enforcement, medical providers, ambulatory services, etc.), and other types of communication messages.

In an additional aspect, the seat belt firearm holster 100 may be in communication with a computing device 160 (e.g., wireless communication device, television, laptop, computer, tablet, hand held communication device, wearable device, and the like) that may include a graphical user interface (GUI) 162 enabled to display on the device 160 one or more user interface controls for a user to interact with the GUI 162. For example, the GUI 162 may display an alert message, such as displaying an audible and/or visual alert on the GUI 162 “ALERT! An unidentified object or person is approaching to the rear of the vehicle!”

The seat belt holster body 110 may a have a top side 115, a bottom side 117 (including a first side 116 that may be a right or left side depending on orientation in relation to the top side 115, and a second side 118 that may be a right or left side depending on orientation in relation to the bottom side 117) depending on the orientation in viewing the seat belt firearm holster 100.

The seat belt firearm holster 100 may also include a male seat belt buckle attachment 102 coupled to the seat belt holster body 110 enabling the male seat belt buckle attachment 102 to secure the seat belt holster body 110 to a vehicle seat belt component. In one aspect, the seat belt firearm holster 100 may also include a female seat belt buckle attachment 108 coupled to at least a portion of the seat belt holster body 110 enabling the female seat belt buckle attachment 108 to secure the seat belt holster body 110 to an additional vehicle seat belt component. More specifically, the male seat belt buckle attachment 102 may be coupled to at least a portion or selected area of the bottom side 117. The female seat belt buckle attachment 108 may be coupled to at least a portion or selected area of the top side 115. It should be noted that the male seat belt buckle attachment 102 may be interchangeably coupled to at least a portion or selected area of the top side 115 rather than to at least a portion or selected area of the bottom side 117. The female seat belt buckle attachment 108 may be interchangeably coupled to at least a portion or selected area of the bottom side 117 rather than to at least a portion or selected area of the top side 115.

The female seat belt buckle attachment 108 may be a seat belt anchor receptacle having a seat belt securing mechanism means 130 contained therein enabling the female seat belt buckle attachment 108 to selectively receive and actuate attachment to a vehicle male seat belt connector. The seat belt anchor receptacle of the female seat belt buckle attachment 108 (e.g., a female seat belt latch receptacle) may be adapted to receive a latch tongue of a conventional seat belt and shoulder harness assembly.

In various embodiments, the male seat belt buckle attachment 102 comprises a retention means 135 enabling the male seat belt buckle attachment to secure the seat belt holster body 110 to a vehicle seat belt component. More specifically, the retention means 135 may be a plate having an aperture defined within the plate of the retention means 135 that is enabled to be adaptively installed within a vehicle seat belt component.

The seat belt firearm holster 100 may also include one or more extension belts, such extension belts 104 and 106, traversing through at least a portion of the seat belt holster body 110 connected to the female seat belt buckle attachment 108 (e.g., a seat belt anchor receptacle) and the male seat belt buckle attachment 102. In an additional aspect, the one or more extension belts 104 and 106 may be attached to an outer portion, such as, for example, to the first side 116 and/or the second side 118, of the holster body 110 and connected to the female seat belt buckle attachment 108 and the male seat belt buckle attachment 102.

The seat belt holster body 110 may also include a securing channel 119 traversing along at least a portion of the outer edges of the seat belt holster (such as the outer edge of the first side 116 or second side 118). The securing channel 119 enables seat belt holster body 110 to slidably adjust to one or more locking positions using one or more locking means 120 or 122 in relation to the male seat belt buckle attachment 102 (and/or extension belt 104) and the female seat belt buckle attachment 108 (and/or extension belt 106). In one aspect, the one or more locking means 120, 122 may be directly coupled to the male seat belt buckle attachment 102 (and/or extension belt 104) and the female seat belt buckle attachment 108 (and/or extension belt 106).

The locking means 120 or 122 may be an adjustable clip, or other securing device, that may clip and/or slide into and/or along the securing channel 119 and clamp onto the securing channel 119. The locking means may be any type of fastening device known in the art or developed in the future. Examples of locking means 120 or 122 further include, but are not limited to, a screw (i.e., a threaded structure), a bolt/nut combination, a dowel, a rivet, a pin, a plug, and the like fastening devices.

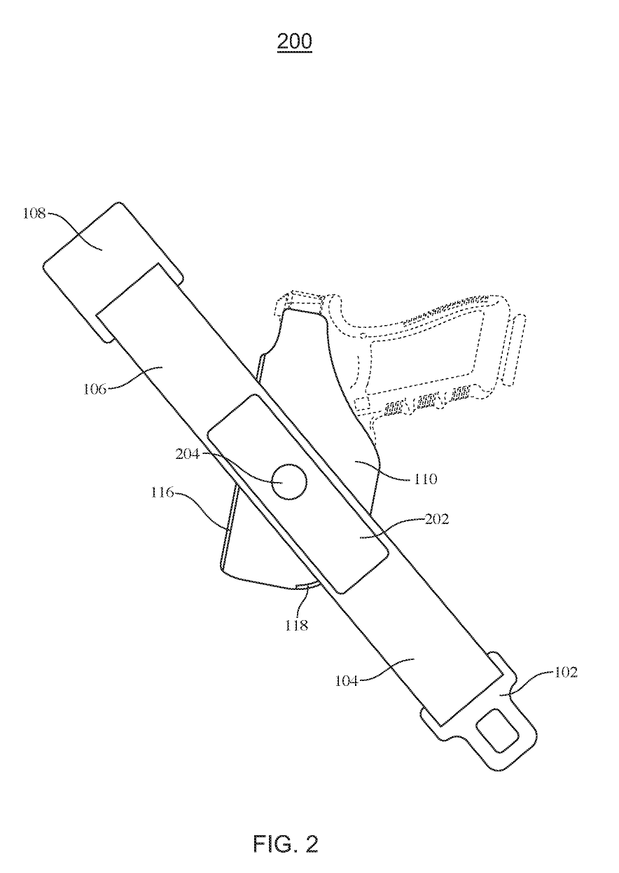

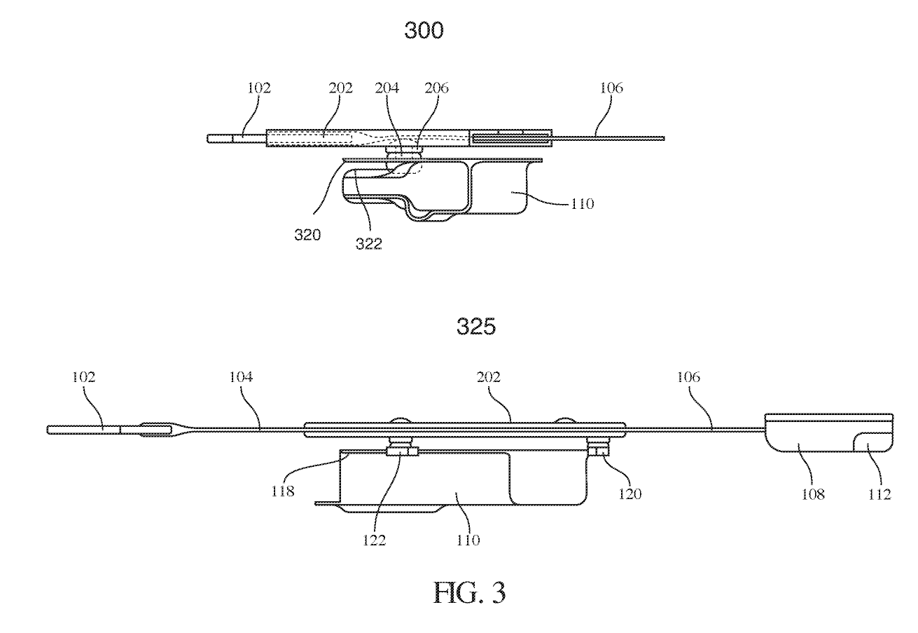

With reference now to FIG. 2, FIG. 2 is a rear view of the seat belt firearm holster 100 of FIG. 1. In addition to illustrating the male seat belt buckle attachment 102, the female seat belt buckle attachment 108, the seat belt holster body 110, and extension belts 104 and 106, FIG. 2 shows that the seat belt firearm holster 100 further comprises a pad 202 (e.g., a cushion padding) attached to the seat belt holster body 110. In one aspect, the pad 202 may be directly coupled to seat belt holster body 110, the male seat belt buckle attachment 102 (and/or extension belt 104), the female seat belt buckle attachment 108 (and/or extension belt 106), or a combination thereof. In one aspect, the extension belts 104, 106 may be one continuous or single belt and coupled between the pad 202 and the seat belt holster body. Furthermore, a rotating locking clip 204 may be attached to the seat belt holster body 110, as illustrated in FIG. 3. In one aspect, the rotating locking clip 204 may be and/or may include a rivet, a screw, a pin, a bolt, a fastener, a clip, a nail, a spring, a bracket, a nut, a slot, a rod, a clamp, an adhesive, the locking means 120 or 122, or a combination thereof.

Turning now to FIG. 3, a diagram of the seat belt firearm holster 100 having a rotating clip and being rotated to a first position 300 and a second position 325. In addition to illustrating the male seat belt buckle attachment 102, the female seat belt buckle attachment 108, the seat belt holster body 110, extension belts 104 and 106, and pad 202, FIG. 3 shows that the seat belt firearm holster 100 further comprises a rotating locking clip 204. The rotating locking clip 204 may be attached to the seat belt holster body 110, the extension belts 104 and 106, or a combination thereof. The rotating locking clip 204 may include a rotation means 206. For example, the rotation means 206 may be connected to either seat belt holster body 110 or the rotating locking clip 204 may be alternatively connected to the male seat belt buckle attachment 102 (and/or extension belt 104), the female seat belt buckle attachment 108 (and/or extension belt 106), or a combination thereof, or vice versa.

In an additional aspect, the rotation means 206 may be attached to an outer surface of the seat belt holster body 110 enabling the seat belt holster body 110 to rotate via the rotation means 206 (which may be secured/coupled to the male seat belt buckle attachment 102 (and/or extension belt 104), the female seat belt buckle attachment 108 (and/or extension belt 106), or a combination thereof) to one of a plurality of temporary locking positions, such as the first locking position 300 or the second locking position 325. The rotation means 206 may be a rotating button and/or the rotation means 206, that may be coupled together to enable the seat belt holster body 110 to rotate to one of the plurality of temporary fixed positions. Also, the rotating locking clip 204 may be a holding plate attached to the rotation means 206 (e.g., rotating button) with the rotation means 206 including a quick release clip enabling the seat belt holster body 110 to be released from the rotating locking clip 204.

More specifically, the rotating locking clip 204 may be directly coupled to the extension belts 104 and 106 and at a position corresponding to rotation means 206 coupled to the seat belt holster body 110. That is, the rotating locking clip 204 being provided with a clip for clipping and securing the rotating locking clip 204 to the rotation means 206. The rotating locking clip 204 may have a multi-stage opening on a center position thereof with the rotation means 206 rotatably received in the multi-stage opening of the rotating locking clip 204. The rotating locking clip 204 holding together the rotation means 206 in a way such that the seat belt holster body 110 may be rotatable relative to the extension belts 104 and/or 106. Also, the rotating locking clip 204 may include a releasing means for securely receiving the rotation means 206 and/or quickly releasing the rotation means 206 from the rotating locking clip.

In an additional aspect, the seat belt holster body 110 may include a plate 320 (e.g., a U-Shape, V-Shape, or other configuration) that is coupled to the one or more locking means 120, or 122. The plate 320 may be an extension plate extending from the seat belt holster body 110 so as to create a receiving section (e.g., a receiving cavity) to receive the rotating locking clip 204 and secure the seat belt holster body 110 to the rotating locking clip 204. The one or more locking means 120 or 122 may be coupled to the seat belt holster body 110 at an end portion of the plate 320 (e.g., at the apex of the U-Shape, V-Shape plate). In this way, the plate 320 enables the seat belt holster body 110 to be attached to the rotating locking clip 204 via the one or more locking means 120 or 122. That is, as the wearer of the seat belt holster body 110, the seat belt holster body 110 may engage and slidably receive the rotating locking clip 204 and connect to the one or more locking means 120 or 122 to secure the seat belt holster to the rotating locking clip.

In one aspect, the plate 320 may be parallel to a surface 322 of the seat belt holster body 110. The plate 320 may be elastic or “pliable” and can be placed over the rotating locking clip 204 so that the seat belt holster body 110 remains on the outside of the belt. The plate 320 may be positioned on the seat belt holster body 110 so as to be placed between the seat belt holster body 110 and either the male seat belt buckle attachment 102 (and/or extension belt 104), the female seat belt buckle attachment 108 (and/or extension belt 106), or a combination thereof. The rotating locking clip 204 and/or the one or more locking means 120 or 122 may include a quick release means/device so as to enable the seat belt holster body 110 to be released from rotating locking clip 204 and/or the one or more locking means 120 or 122. That is, the quick release means/device of the rotating locking clip 204 and/or the one or more locking means 120 or 122 enables the seat belt holster body 110 to be released from the male seat belt buckle attachment 102 (and/or extension belt 104), the female seat belt buckle attachment 108 (and/or extension belt 106), or a combination thereof.

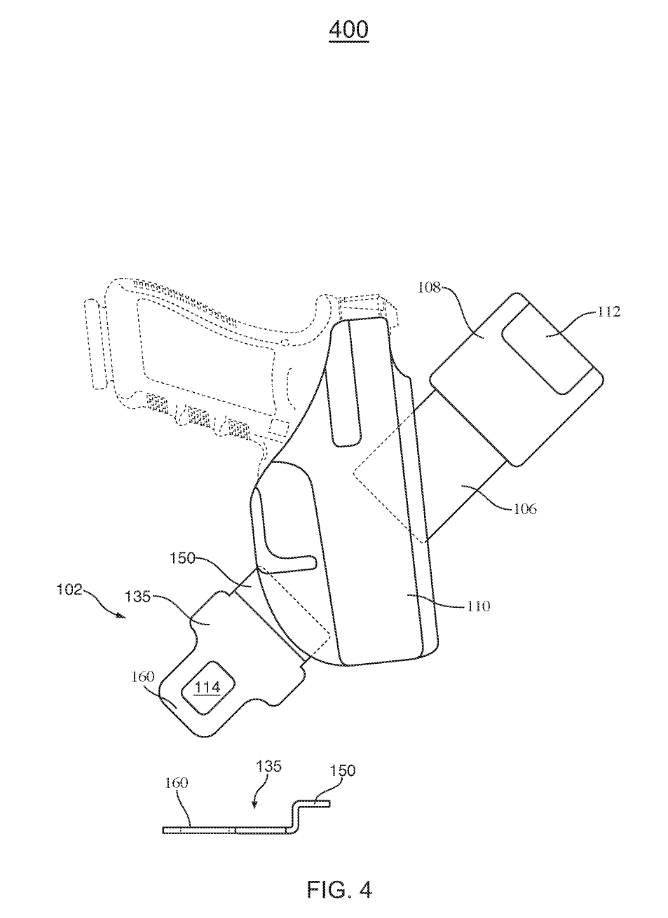

With reference now to FIG. 4, the seat belt holster 100 illustrates that the female seat belt buckle attachment 108 (e.g., a seat belt anchor receptacle) and the male seat belt buckle attachment 102 may be directly coupled to the seat belt holster body 110. In this aspect, the extension belts 104 and 106 may be excluded from the seat belt holster body 110 and/or contained within the seat belt holster body 110, but concealed from view. In this way, the extension belts 104 and 106 may form or be included within one or more side walls of the seat belt holster body 110 and concealed and secured therein. In an additional aspect, the female seat belt buckle attachment 108 or the male seat belt buckle attachment 102 may be coupled to the seat belt holster body 110 via channel 119 as described in FIG. 1.

As an additional aspect, the retention means 135, that enables the male seat belt buckle attachment to secure the seat belt holster body 110 to a vehicle seat belt component, may have a first portion 150 and a second portion 160 forming a non-planer, s-shaped plate. The first portion 150 of the retention means 135 may be at least partially housed within the seat belt holster body 110. The second portion 160 of retention means 135, having an aperture 114, enables the retention means 135 to adaptively install the male seat belt buckle attachment 102 within a vehicle seat belt component. The first portion 150 may be at least a half inch or at least one inch in length and the second portion 160 may be at least 2 inches in length. The entire half inch of the first portion 150 may be housed and/or encased within the seat belt holster body 110.

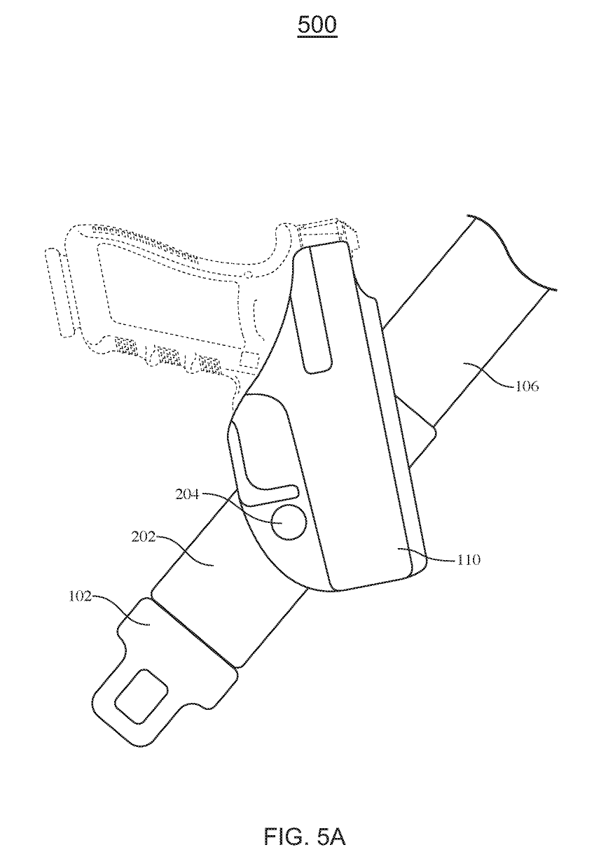

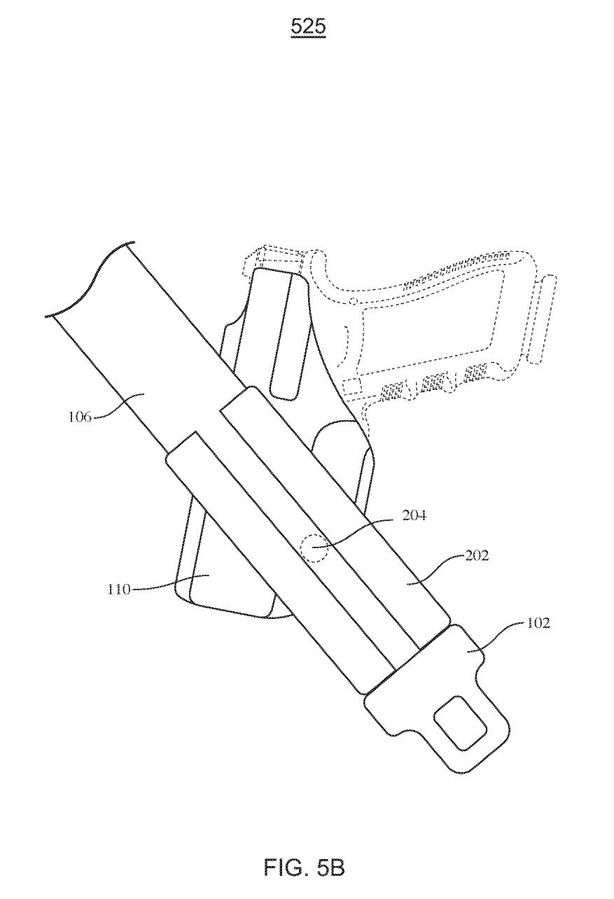

Turning now to FIGS. 5A-5B, a diagram of the seat belt firearm holster 100 having the rotating locking clip 204, having a rotating clip/pin, coupled to the male seat belt buckle attachment 102, the female seat belt buckle attachment 108, the seat belt holster body 110, extension belts 104 and 106, and pad 202, or a combination thereof in a frontal view 500 and rear view 525. For example, the rotating clip 204 may be in part attached to the seat belt holster body 110 and a portion of the male seat belt buckle attachment 102, the female seat belt buckle attachment 108, the extension belts, such as for example, extension belt 106, or a combination thereof. In this way, the seat belt holster body 110 may be attached and/or released from the male seat belt buckle attachment 102, the female seat belt buckle attachment 108, the extension belts, such as for example, extension belt 106, or a combination thereof.

Consider the following example. Assuming a driver/passenger (e.g., “user”) enters a vehicle with a seat belt system having at least the male seat belt buckle attachment 102, the female seat belt buckle attachment 108, the seat belt holster body 110, extension belts 104 and 106, pad 202, or a combination thereof included therein. A portion of the rotating locking clip 204, having a rotating clip/pin may be secured to extension belt 106. The seat belt holster body 110 also may have a portion of the rotating locking clip 204 coupled thereto. The user may secure the portion of the rotating locking clip 204 coupled to the seat belt holster body 110 to the portion of the rotating locking clip 204 coupled to extension belts 106. The user may adjustably slide the seat belt holster body 110 along a portion of the pad 202 and/or extension belt 106 to position the seat belt holster body 110 in a more comfortable position of the user such as, for example, to enable the seat belt holster body 110 to be located in a position along the extension belt that is more comfortable for the user or disguisable/concealed from the view of other persons.

Referring now to FIG. 6, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operable with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network or IoT network. In a distributed cloud computing environment, program modules may be located in both local and remote computer system storage media including memory storage devices.

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), an IoT network, and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to, microcode, device drivers, redundant processing units, external disk drive arrays, RAID systems, tape drives, and data archival storage systems, etc.

Referring now to FIG. 7, illustrative cloud computing environment 50 is depicted. As shown, cloud computing environment 50 comprises one or more cloud computing nodes 10 with which local computing devices used by cloud consumers, such as, for example, seat belt holster 100, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid Clouds as described hereinabove, or a combination thereof. This allows cloud computing environment 50 to offer infrastructure, platforms and/or software as services for which a cloud consumer does not need to maintain resources on a local computing device. It is understood that the types of computing devices 100 and 54A-N shown in FIG. 2 are intended to be illustrative only and that computing nodes 10 and cloud computing environment 50 can communicate with any type of computerized device over any type of network and/or network addressable connection (e.g., using a web browser).

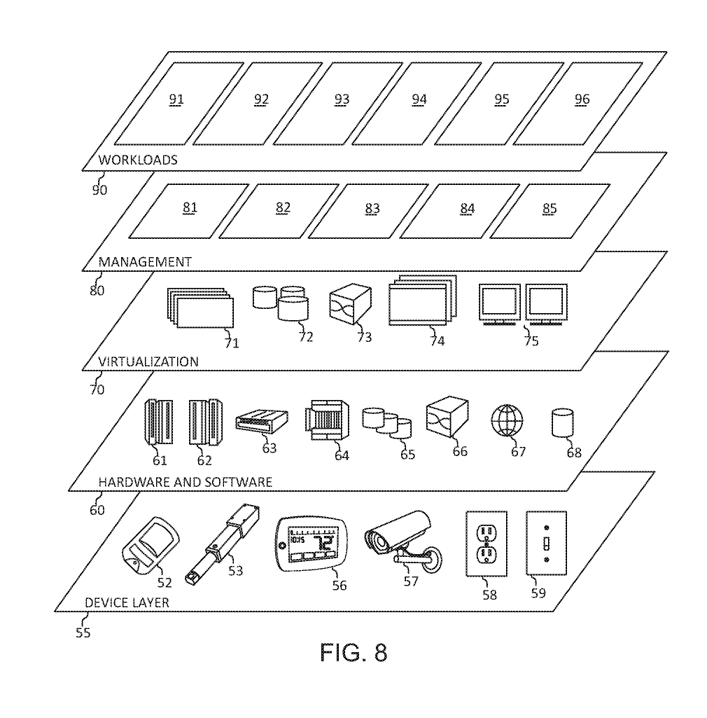

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to, various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various configuring settings for various computer-controlled devices for intelligent seat belt holster service and communication workloads and functions 96. In addition, configuring settings for various computer-controlled devices using workloads and functions 96 for intelligent seat belt holster service and communication may include such operations as data analysis (including data collection and processing from various environmental sensors), semantic analysis, image analysis, control input analysis, device analysis, and/or data analytics functions. One of ordinary skill in the art will appreciate that the configuring settings for various computer-controlled devices using workloads and functions 96 for intelligent seat belt holster service and communication may be in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

The present invention may include a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The diagrams in the above figures illustrate the structure, functionality, and operation of possible implementations of seat belt holster 100 according to various embodiments of the present invention. Although the invention has been described with respect to particular embodiments, such embodiments are for illustrative purposes only and should not be considered to limit the invention. Various alternatives and changes will be apparent to those of ordinary skill in the art upon reading this application.

1. A seat belt holster, comprising:
a holster body defining a handgun receiving pocket;
a male seat belt buckle attachment coupled to a first side of the holster body; and
a seat belt anchor receptacle coupled to a second side of the holster body.

2. The seat belt holster of claim 1, wherein the male seat belt buckle attachment comprises a retention means enabling the male seat belt buckle attachment to secure the holster body to a vehicle seat belt component.

3. The seat belt holster of claim 1, wherein the male seat belt buckle attachment comprises a plate having an aperture defined within the plate enabled to adaptively install within a vehicle seat belt component.

4. The seat belt holster of claim 3, wherein the plate includes a first portion and a second portion forming a non-planer, s-shaped plate, the second portion including the aperture.

5. The seat belt holster of claim 1, wherein the seat belt anchor receptacle comprises a seat belt securing mechanism contained therein enabling the seat belt anchor receptacle to selectively receive and actuate attachment by the seat belt securing mechanism to a vehicle male seat belt connector.

6. The seat belt holster of claim 1, further comprising an extension belt traversing through at least a portion of the holster body connected to the seat belt anchor receptacle and the male seat belt buckle attachment.

7. The seat belt holster of claim 1, further comprising an extension belt attached to an outer portion of the holster body and connected to the seat belt anchor receptacle and the male seat belt buckle attachment.

8. The seat belt holster of claim 1, further comprising:
a rotating button attached to an outer surface of the holster body enabling the holster body to rotate to one of a plurality of temporary fixed positions;
a holding plate attached to the rotating button, the rotating button including a quick release clip enabling the holster body to be released from the holding plate; and
an extension belt traversing through the holding plate and connected to the seat belt anchor receptacle and the male seat belt buckle attachment.

9. The seat belt holster of claim 8, further including:
a slidable clip to enable the holding plate to be slidably adjusted along the extension belt; and
a pad coupled to at least a portion of the holster body.

10. The seat belt holster of claim 1, further including one or more Internet of Things (IoT) devices in communication with one or more computing devices, wherein the IoT devices are in an IoT computing network.

11. An apparatus, comprising:
a seat belt holster body defining a handgun receiving pocket for receiving a firearm;
a male seat belt buckle attachment coupled to a first side of the seat belt holster body enabling the male seat belt buckle attachment to secure the seat belt holster body to a vehicle seat belt component;
a seat belt anchor receptacle, coupled to a second side of the seat belt holster body, having a seat belt securing mechanism contained therein enabling the seat belt anchor receptacle to selectively receive and actuate attachment to a vehicle male seat belt connector; and
an extension belt attached to an outer portion of the seat belt holster body and connected to the seat belt anchor receptacle and the male seat belt buckle attachment.

12. The apparatus of claim 11, wherein the male seat belt buckle attachment is a plate having an aperture defined within the plate enabled to adaptively install within a vehicle seat belt component.

13. The apparatus of claim 12, wherein the plate includes a first portion and a second portion forming a non-planer, s-shaped plate, the second portion including the aperture.

14. The apparatus of claim 11, further comprising:
a rotating button attached to an outer surface of the seat belt holster body enabling the seat belt holster body to rotate to one of a plurality of temporary fixed positions;
a holding plate attached to the rotating button, the rotating button including a quick release clip enabling the seat belt holster body to be released from the holding plate;
an extension belt traversing through the holding plate and connected to the seat belt anchor receptacle and the male seat belt buckle attachment; and
one or more Internet of Things (IoT) devices in communication with one or more computing devices, wherein the IoT devices are in an IoT computing network.

15. An apparatus, comprising:
a seat belt holster body defining a handgun receiving pocket for receiving a firearm;
a male seat belt buckle attachment coupled to a first side of the seat belt holster body, the male seat belt buckle attachment having a retention means enabling the male seat belt buckle attachment to secure the seat belt holster body to a vehicle seat belt component;
a seat belt anchor receptacle, coupled to a second side of the seat belt holster body, having a seat belt securing mechanism contained therein enabling the seat belt anchor receptacle to selectively receive and actuate attachment to a vehicle male seat belt connector; and
an extension belt traversing through the holding plate and connected to the seat belt anchor receptacle and the male seat belt buckle attachment.

16. The apparatus of claim 15, wherein the seat belt holster having a securing channel traversing along at least a portion of the outer edges of the seat belt holster, wherein the securing channel enables the male seat belt buckle attachment and the seat belt anchor receptacle to slidably adjust to one or more locking positions.

17. The apparatus of claim 15, wherein the retention means is a plate having a first portion and a second portion forming a non-planer, s-shaped plate, the first portion at least partially housed within the seat belt holster and the second portion having an aperture to adaptively install within a vehicle seat belt component.

18. The apparatus of claim 17, wherein the first portion of the plate is at least one inch in length and the second portion is at least 2 inches in length.

19. The apparatus of claim 15, further comprising:
a rotating locking clip attached to an outer surface of the seat belt holster body enabling the seat belt holster body to rotate to one of a plurality of temporary locking positions; and
a pad coupled to at least a portion of the holster body.

20. The apparatus of claim 15, further including one or more Internet of Things (IoT) devices, coupled to at least a portion of the holster body, in communication with one or more computing devices, wherein the IoT devices are in an IoT computing network.
